(19) United States
(12) Patent Application Publication
(10) Pub. No.: US 2002/0147516 A1
(43) Pub. Date: Oct. 10, 2002

(54) Brand equity system and method of increasing the same

(76) Inventor: Charles L. Jones, Stevensville, MI (US)

Correspondence Address: WHIRLPOOL PATENTS COMPANY - MD 0750, 500 RENAISSANCE DRIVE - SUITE 102, ST. JOSEPH, MI, 49085, US

(21) Appl. No.: 09/767,431

(22) Filed: Jan. 22, 2001

(51) Int. Cl. G06F 17/60

(52) U.S. Cl. 700/97

(57) ABSTRACT

Disclosed is a product and process of creating a visual brand system to increase brand equity in a product.

### BACKGROUND OF THE INVENTION

The invention relates to a product and process of creating a visual brand system to increase brand equity in a product. The United States, along with most other countries in the world, are increasingly becoming branded societies. Brand equity is important in a product's life because the brand equity creates a great drawing power to the brand. Brand equity is also important in serving as an intellectual capital in a company; to the extent that even strong brands can be used as collateral or are otherwise treated like property of an estate. Indeed, brand equity can be some of the most important assets to a company. As a corollary, a company with a strong brand equity portfolio is at a better competitive advantage than other competitors.

Brand equity management can yield benefits to a company. First, it may allow a price premium charge as compared to other competitor's products with less brand equity. It can help build strong brand names that simplify the decision process. Brand equity can give some comfort to buyers unsure of their decisions. Strong brand equity can maintain a higher awareness in the minds of the consumers for the company's products. Brand equity can be used to leverage new products during introduction. Brand equity can be used to link a quality image that buyers want to be associated with. Finally, brand equity can lead to higher initial product trial and/or repeat purchasing, thus leading to increased overall sales.

Increasing overall sales growth generally includes identifying and expanding key factors. For example, increasing market penetration leads to overall sales growth. Other factors include market development, market expansion (e.g., expanding geographical coverage), product diversification, and market integration. Yet another factor includes product development, most often characterized as brand extension. Unlike line extension that takes a brand name into a new category of goods or new use, brand extension is a way to transfer the equity of a brand across category boundaries or across user universes.

Although increasing brand equity in a product is useful, creating brand equity in a line of products is even better. It is well understood that, for example, certain lines of sports car within a brand have the same or similar appearance. Strong brand equity is created when any one car in the line is driven and appreciated by passerbys. To create success in a brand equity management portfolio, it is often necessary to monitor customer perceptions of the product vis a vis the competitors. Product differentiation among competitors is important. Creating the #1 brand is very useful for a company. However, one aspect of creating a top brand is to create a brand equity generating overall attribute or attribute cluster. In this regard, one method of doing so is to establish the brand equity using consistent themes.

The use of creating a consistent “theme” across the products in a product line is known. However, the process or methodologies of doing so are less understood. In addition, while brand equity is often thought of solely within the assets of the company, it is better to identify brand equity as being also part of the perception in the consumer's mind. Accordingly, the successful company that is able to penetrate the consumer's mind to develop the proper branding of the product will create stronger brand equity in the product or product lines. How to do so presents the problem.

### SUMMARY OF THE INVENTION

The foregoing problems are solved and a technical advance is achieved by the present invention. Disclosed is product and process of creating a unified look and feel for products that consumers will associate with a particular brand.

### BRIEF DESCRIPTION OF THE DRAWINGS

FIG. 1 is a flowchart of a method embodying the principles of the present invention.

FIG. 2 is a flowchart of one aspect of the invention.

FIG. 3 is a flowchart of another aspect of the invention.

FIG. 4 is a flowchart of another aspect of the invention.

FIG. 5 is a flowchart of another embodiment of the invention.

FIG. 6 is a flowchart of another embodiment of the invention.

FIG. 7 demonstrates a first product in a product line.

FIG. 8 is an embodiment of a perceptual map.

FIG. 9 is a labeled perceptual map.

FIG. 10 is a chart demonstrating a step in the invention.

FIG. 11 is another chart demonstrating another step in the invention.

### DETAILED DESCRIPTION OF THE EMBODIMENTS

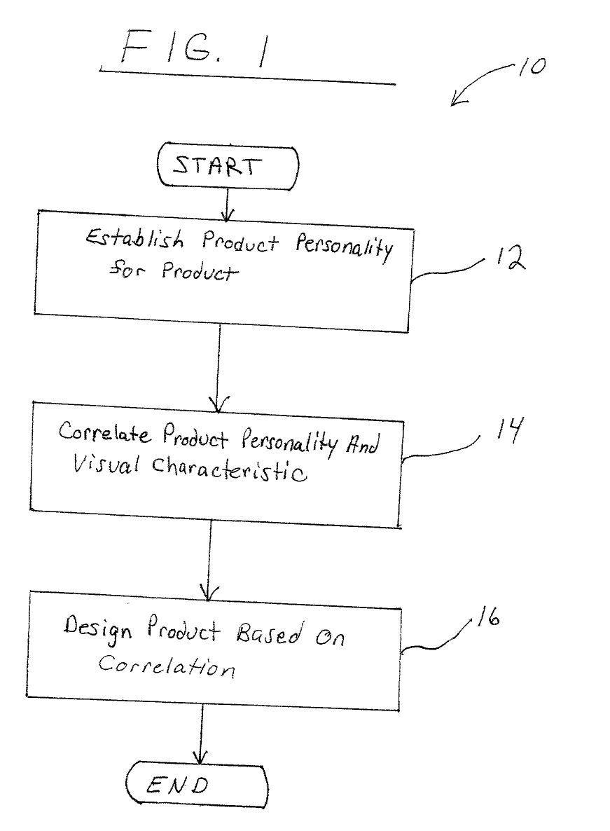

FIG. 1 is an overall flowchart of a method embodying g the principle s of the invention. Shown is a product 10 made by the process of establishing 12 a product personality for a product; correlating 14 the product personality with a visual characteristic; and designing 16 a product based on the correlation. By this, the invention is capable of determining a particular product's appearance by understanding the evolution and goals of the various brands'positioning; establishing a desired brand personality for the various brands; defining a visual characteristic to current, desired and competitive brands, and identifying opportunities for creating a visual brand differentiation.

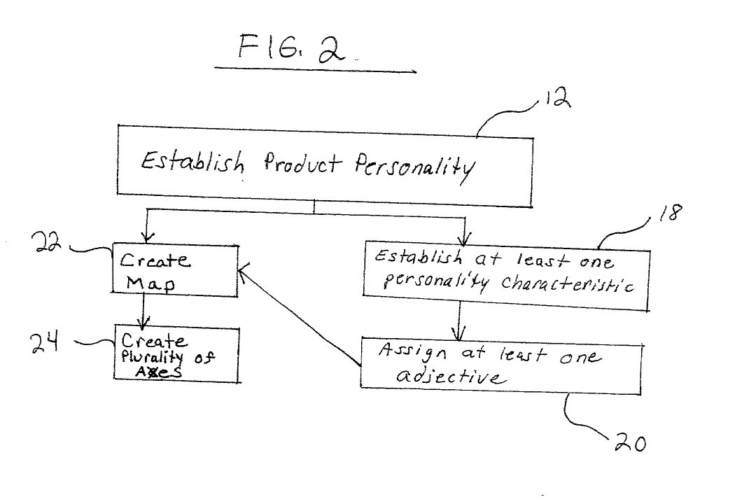

FIG. 2 is a further illustration of the step of establishing 12 a product personality. The step of establishing 12 the product personality further includes the step of establishing 18 at least one personality characteristic of the product. Furthermore, the step of establishing 18 at least one personality characteristic further includes the step of assigning 20 at least one adjective to the personality characteristic. As shown in FIG. 2, the step of establishing 12 a product personality may further include the step of creating 22 a perceptual map. Thus in one embodiment, the product personality may comprise a sum total of the plots on the map, or some other representation thereof. The step of creating 22 a perceptual map may further be a refinement of the step of assigning 20 at least one adjective to the personality characteristic. The perceptual map may also include creating the map with a plurality of axes that are exclusive and differentiated.

Perceptual Mapping is a tool or process used in marketing research for charting the way individuals selected from the target market perceive different companies, products or brands. Perceptual Mapping is also called Position Mapping. There are several characteristics associated with mapping perceptions. One characteristic is to use geometry to create a graphic representation of the map. The map may also include attribute-based maps or maps of brands relative to each other. The products measured can almost be anything identifiable, such household goods, automotive, industrial, people, or activities. Perceptual maps, when done properly, can show how the products are viewed in the consumer's minds and thus suggest how they can be positioned to maximize sales or preferences. Maps may also identify a product weakness and can be used to point out flaws in the product development stage. Maps may also be used to identify differences among groups (e.g., how men versus women, adults versus children, etc.) may perceive a product. Other maps include joint perception & preference maps, vector models, and ideal-point models (unfolding model).

As with most maps of this sort, the map is characterized by one or more axes. For example, in evaluating a regular household medicine, the axes may include and be labeled as an Ease-Of-Use axis; Effect-On-Digestion axis; Price axis, Effectiveness axis; and Lasting-Duration axis. In preparing the map, the axes chosen will normally be associated with the underlying product(s) studied.

To generate the plotting points or coordinates, raw data is accumulated and plotted. A first step could be to poll the proper audience and solicit answers, such as asking “rating” questions by a Likert scale question. This type of question asks the responder to rate (usually from 1 to 5, with 1 being a strong agreement and 5 being a strong disagreement) the products. The Likert questions could be tailored for all the attributes of the product and tied to the labels associated with the axes. Another method of obtaining attribute ratings is to use a Semantic Differential scale in which the responder is asked to place an X (or other mark) along a sliding scale, in which the poles of the scale are opposites (e.g., Effective versus Non-Effective). Each scale may be coordinated with the proposed axes of the map. To plot these results, there are several mathematical and statistical methodologies, including using a multiple discriminant analysis, multidimensional scaling or factor analysis.

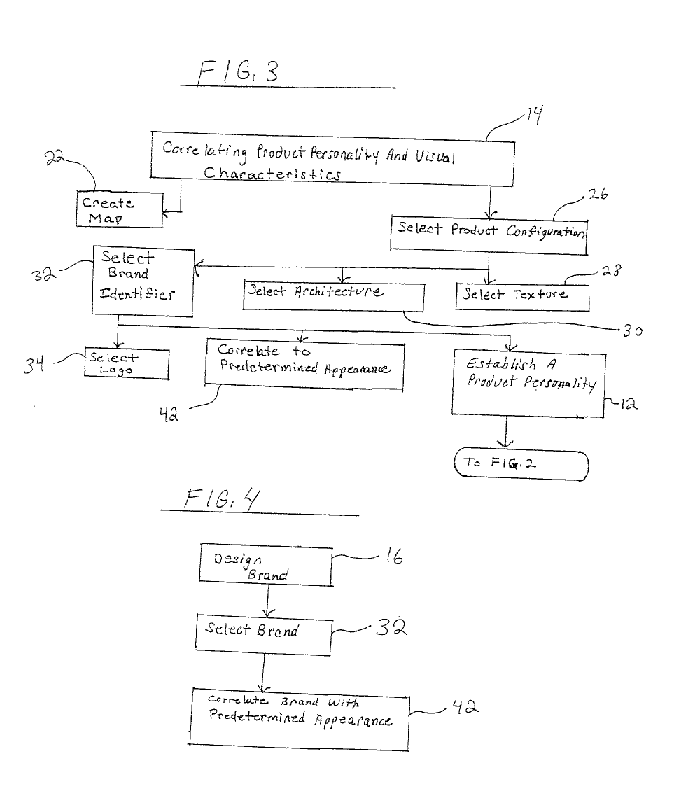

FIG. 3 is a further illustration of the step of correlating 14 the product personality. Additionally, this step may further include the step of selecting 26 a configuration for at least a component of the product. Product configurations may vary but may include, but are not limited to, selecting 28 a texture or selecting 30 an architecture of at least a component of the product. The step of selecting 26 the product configuration may further include the step of selecting 32 a brand identifier of the product, such as a logo 34. The step of selecting 32 the brand identifier may further comprise the step of establishing 18 at least one personality characteristic of the product. As shown in FIG. 2, the step of establishing 18 at least one personality characteristic further includes the step of assigning 20 at least one adjective to the personal characteristic. Similarly, the step of correlating 14 the product personality with the visual characteristic may further include the step of correlating the product personality with a perceptual map.

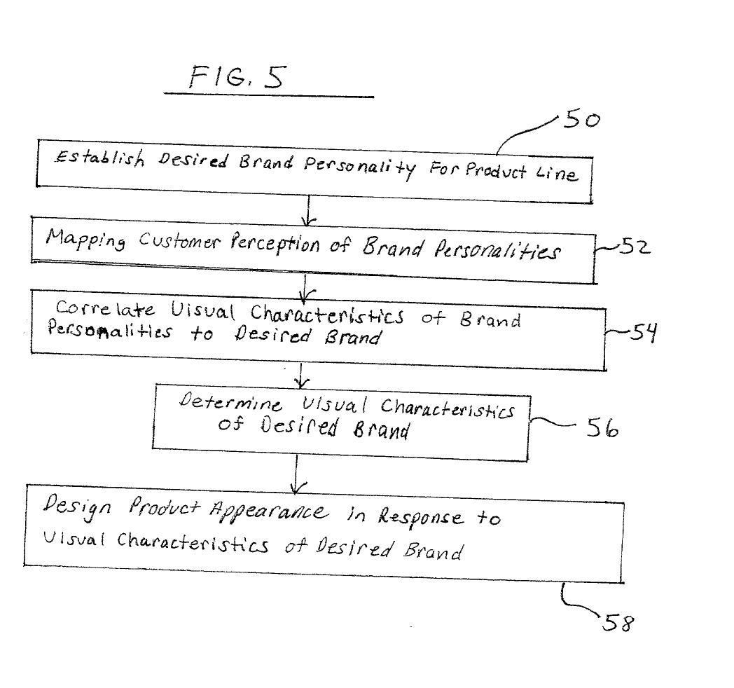

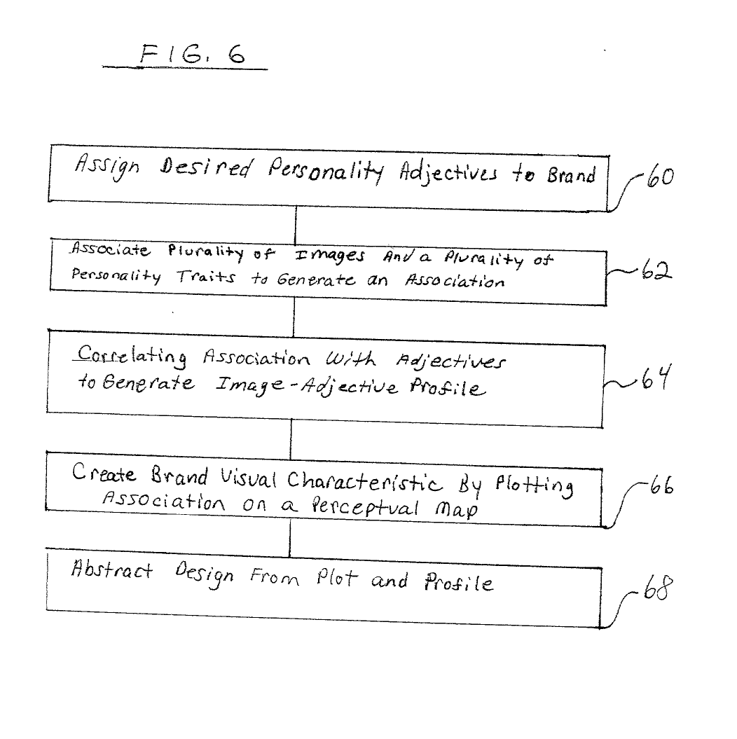

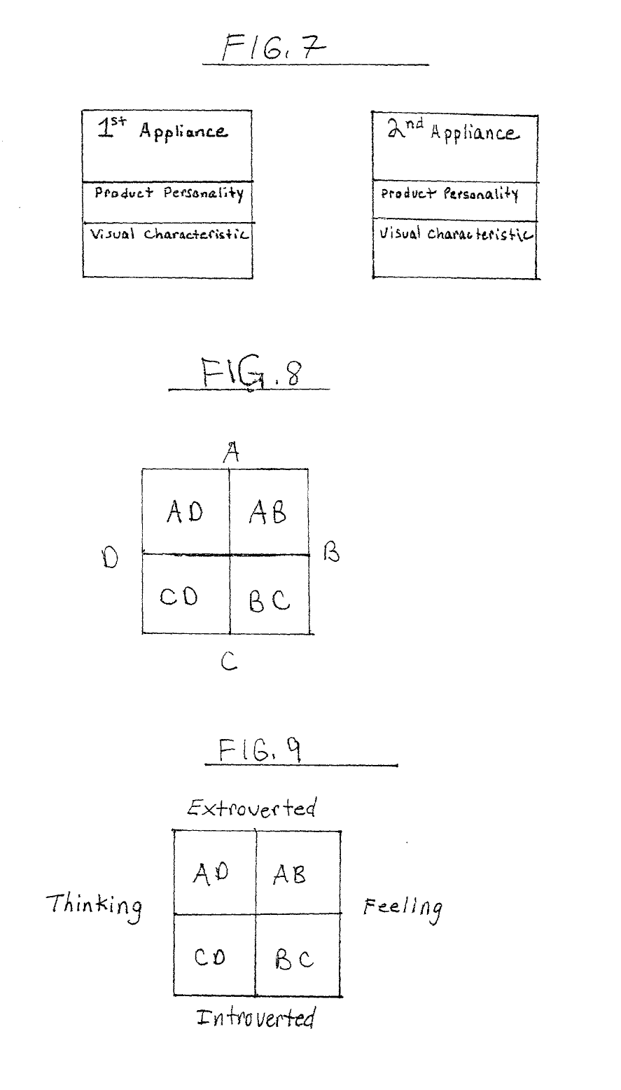

FIG. 4 is a further illustration of the step of designing 16 a product. The step of designing 16 a product based on the correlation may further comprise the step of selecting 32 a brand to create a brand identifier. The step of selecting 32 to creating a brand identifier further includes the step of correlating 42 the brand identifier with a predetermined appearance of at least a component of the product.

FIG. 5 illustrates another embodiment of the invention. The invention may also comprise the steps of: establishing 50 desired brand personalities for a product line; mapping 52 customer perceptions of the brand personalities; correlating 54 visual characteristics of the brand personalities to a desired brand; determining 56 visual characteristics of the desired brand; and designing 58 the product appearance in response to the visual characteristics of the desired brand.

FIG. 6 illustrates another embodiment of the invention. Shown is a method of creating brand equity in a product line, comprising the steps of: assigning 60 desired personality adjectives to a current brand; associating 62 a plurality of images with a plurality of dominant personality traits to generate an association between the plurality of images with the plurality dominant personality traits; correlating 64 the association of the images and traits with the adjectives to generate an image adjective profile; creating 66 a brand visual characteristic by plotting the association on a perceptual map; and abstracting 68 a design from the plot and the image adjective profile to create a brand visual identifier.

As shown in FIG. 7, as with any embodiment herein, the products may be a first 70 or second 71, or series of products within a product line, or across product lines. The process of the invention creates a series of products that have similar visual characteristics 72 correlated to product personalities 74. For example, in the home appliance industry, these include at least one of a washer, dryer, refrigerator, freezer, oven, stove, range, counter top appliance, cooktop, grill, hood, dishwasher, and microwave oven, or the like. Other equipment or appliances may also include fabric refreshers, humidifiers, de-humidifiers, air purifiers, ice makers, water dispensers, or the like. In effect, one non-exclusive result is that the appliances may have a similar appearance and design methodology. This similar design appearance may manifest as part of or as a component of the product. For example, this component may include at least one of a panel, frame, top, bottom, rollers, stand, contour, dispenser, plating, pan, icon, graphic, color, texture, display, LED display, lever, tray, shelf, bar, lighting, switch, door, handle, knob, button, dial, siding, backing, interior, facade, and shape, among other components.

Returning to FIGS. 1 to 6, and FIG. 8, one application of the methodology above is related to the household appliance industry. For example, a company may manufacture various products under different brands, either for sale under the company name or for private branding. As shown in FIG. 8, to create a perceptual map, the axes may be defined. Although shown in FIG. 8 as a map with 4 quadrants, it should be appreciated that any number of axes may be used thus resulting in any number of intermediate bounded areas. In this example, though, shown is a 2 axis map creating 4 quadrants. The ends of the axes may be labeled with axis labels. These axis labels can correspond to any number of personality characteristics, such as adjectives. Thus, as shown in FIG. 8, the labels A, B, C, and D may correspond to various adjectives. The mapping also creates quadrants AB, BC, CD, and AD. The selection of adjectives or other personality characteristics largely depends on the nature of the underlying activity or product and what is desired. For example, the personality characteristics or adjectives may include, but of course are not limited to, words such as charismatic, dynamic, outgoing, friendly, outward, sociable, approachable, accessible, rational, logical, reasonable, sensible, practical, reliable, intelligent, analytical, modest, subtle, inward, reserved, elegant, classic, humble, pure, passionate, emotional, compassionate, intuitive, sensory, tactile, affectionate, extroverted, thinking, introverted, feelings, creative, responsible, pragmatic, practical, useful, inexpensive, expensive, thoughtless, silly, status conscious, immodest, pretentious, grandiose, flamboyant, and etc. The list of adjectives or personality characteristics is not fixed and is intended to include synonyms, antonyms, similar functional words, other related words, etc.

FIG. 9 shows an embodiment of the perceptual map. Once a number of adjectives or personality characteristics are determined, however many, these may be put onto the end points of the map axes as axes labels. One method of doing so is to create opposite characteristics at each end point of the same axis. For example, one end of an axis could be identified as “Happy” while the other end is “Unhappy”. By doing so will help, but is not necessarily required, to plot the map later. In FIG. 9, the same axis is labeled with “Introverted” and “Extroverted” as opposites and with “Feeling” and “Thinking” as somewhat distinct and unique. By keeping the axes different, a perceptual map can be created. With respect to appliances, other axes labels that are opposites include “modem” vs. “antique” or “flashy” vs. “subdued”, etc. The group of adjectives can be further grouped and classified with a more generic word; and this word can become the axis label.

Next, to facilitate design associated with the map, once the axis labels are determined, the rest of the selected adjectives (as appropriate) may be listed in the form of a table under those axis labels that correspond best to the axis label. For example, Table 1 demonstrates an adjective/personal characteristic table when the axes are labeled with “extroverted” “introverted” “feeling” and “thinking”.

TABLE 1

| Extroverted | Thinking | Introverted | Feeling |
|---|---|---|---|
| Charismatic | Traditional | Modest | Passionate |
| Dynamic | Logical | Subtle | Emotional |
| Outgoing | Reasonable | Inward | Compassionate |
| Friendly | Sensible | Reserved | Intuitive |
| Outward | Practical | Elegant | Sensory |
| Sociable | Reliable | Classical | Tactile |
| Approachable | Intelligent | Humble | Affectionate |
| Accessible | Analytical | Pure | Creative |

Next, various product configuration or appearance characteristics can be coordinated with the map. Since the range of configurations is nearly limitless, by way of example only, some configurations are described herein. An appliance, such as a refrigerator has a variety of underlying components related to the configuration. For example, the “look” of a refrigerator can be attributed to the handle, the door, the wheels/casters, the shelves, the side panels, the grillwork, etc. Any or all of these components may be so designed to create the product of the invention. For example, selecting various configurations for the door handle and predetermining various “looks” of the handle can create the unified look desired for all handles across all products in the product line. The door handle may have architectural based characteristics to it such as being transparent, opaque, rounded edges, wooden looking, cylindrical, thick, thin, vertical, horizontal, etc. The door handle may also have texture-based characteristics, such as shiny, dull, smooth, rough, finger gripped, grainy (such as a wood grain), patterned (with a preselected or random pattern), metallic, or etc. The door handle may also have a brand-identifier based characteristic to it, such as the logo.

Returning to the coordination of these configurations with the map, the user may then place visual characteristics, such as image cards (cards that have the image or configuration on it) into the table under one or more of the axis label headings which more associates the relationship between the image and the axis label heading. For example, an image of rounded door handles could be placed under the “introverted” and “feeling” headings. Assuming a shiny or glossy black and white checkerboard image is associated with a modern intellectual characteristic, this image card could be placed under “extroverted” and “thinking” headings to associate this modern theme with a consumer who is more sociable (and hence extroverted) and intellectual (and hence “thinks” about things). Assuming that an image of a cobalt jet black handle is also associated with extroverted thinkers, this image can also be placed. By placing the plurality of image cards into the axis label headings, various adjectives and product configurations can be mapped.

As shown in FIG. 9, for example, by placing the checkerboard into the extroverted and thinking columns would correlate this image into the AD quadrant. As more images are placed into the quadrants, it will become apparent that certain images are correlated to various adjectives and also correlated to other images within the quadrant. Accordingly, designing a product that incorporates all the images in quadrant AD would tend to result in a product that appeals to the modem consumer. Therefore, all the products across the product line designed in view of the AD quadrant may each have a unique shiny or glossy checkerboard patterns with any handle being a cobalt jet black handle.

On the other hand, other quadrant designs may yield products that appeal to the more traditional or antique consumer. For example, assuming that a square edged product image and a wooden texture is placed in the introverted and feeling quadrant, then this resulting product may appeal to the traditional consumer and product lines could be developed that all have wooden square handles.

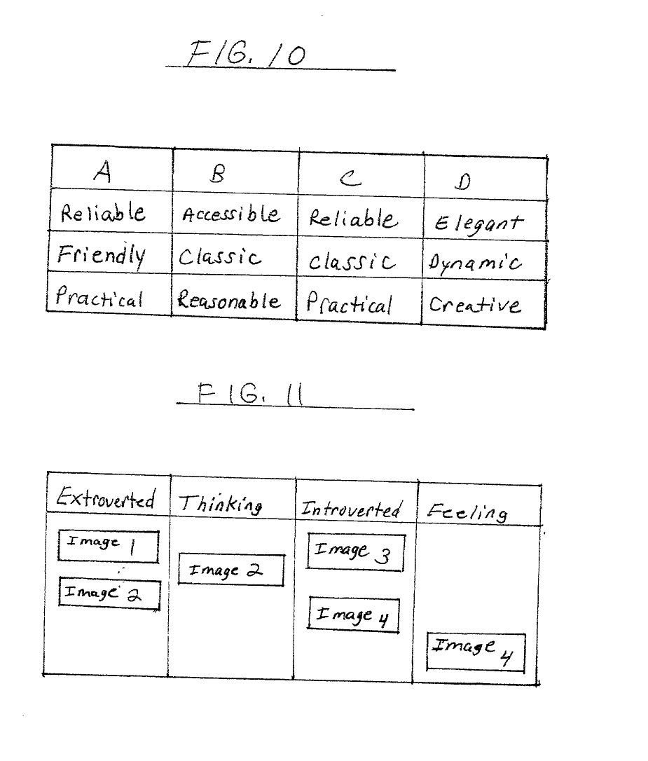

FIG. 10 illustrates another embodiment of the invention in which the invention may be applied to a company's currently existing brands and correlated to competitor's brands. For example, company A is a competitor to companies B, C, and D. In this embodiment, the list of adjectives would be given to a participant, such as a focus group or marketing personnel, etc., with that participant putting the adjectives in the table under the certain brands, and repeating the same adjective, if necessary, across many brands. By way of example in FIG. 10, three adjectives were placed under each brand with the “classic” and “reliable” and “practical” adjective being used multiple times across brands. By reference to Table 1 above, knowing that the participant placed a particular adjective, that adjective is correlated to the axis label identifier at the top of the appropriate column of Table 1. For example, if the participant placed “reliable” in the FIG. 10 table under A and C, this adjective “reliable” correlates to the axis label “Thinking”. By repeating this, each brand of FIG. 10 will yield plot points on the perceptual map. Repeating this for many adjectives (for example, at least more than 3 adjectives per FIG. 10 brand), an area plot will evolve.

FIG. 11 demonstrates the next step in which the image cards as described above that describe various product configurations are then placed by the participant in a table. As shown in FIG. 11, for example, an image card #4 of rounded door handles could be placed under the “introverted” and “feeling” headings. Assuming a shiny or glossy black and white checkerboard image (such as image card #2) is associated with a modern intellectual characteristic, this image card could be placed under “extroverted” and “thinking” headings to associate this modem theme with the a consumer who is more sociable (and hence extroverted) and intellectual (and hence “thinks” about things). Assuming that an image of a cobalt jet black handle is also associated with extroverted thinkers, this image can also be placed. By placing the plurality of image cards into the axis label headings, various adjectives and product configurations can be mapped.

Accordingly, now that the perceptual map associates adjectives with the perceptual map and the perceptual map also associates with product configurations, designing a product based on the product configurations for the brand and designing multiple products within a line under the same brand is obtainable. Thus, for example, a cobalt jet black handle could be used for all products in the line that are geared towards extroverted thinkers. The individual component or the combination of a plurality of components, or the overall product itself may be the visual characteristics or visual identifiers contemplated. Since the products are designed based on a plurality of adjectives and/or product configurations, the products or the line take on or portray a certain personality.

It should be understood that the foregoing relates only to a limited number of embodiments that have been provided for illustration purposes only. It is intended that the scope of invention is defined by the appended claims and that modifications to the embodiments above may be made that do not depart from the scope of the claims.

The embodiments of the invention in which an exclusive property or privilege is claimed are therefore defined as follows:

1. A product made by the process of:
(a) establishing a product personality for a product;
(b) correlating the product personality with a visual characteristic; and
(c) designing the product based on the correlation.

2. The product of claim 1, wherein the step of establishing the product personality further includes the step of establishing at least one personality characteristic of the product.

3. The product of claim 2, wherein the step of establishing at least one personality characteristic further includes the step of assigning at least one adjective to the personality characteristic.

4. The product of claim 3, wherein the step of establishing the product personality further includes the step of creating a perceptual map.

5. The product of claim 1, wherein the step of establishing the product personality further includes the step of creating a perceptual map.

6. The product of claim 5, wherein the step of creating a per ceptual map further includes the step of creating a map with a plurality of axes that are exclusive and differentiated.

7. The product of claim 1, wherein the step of correlating the product personality with a visual characteristic further includes the step of selecting a configuration for at least a component of the product.

8. The product of claim 7, wherein the step of selecting a product configuration further includes the step of selecting a texture of at least a component of the product.

9. The product of claim 7, wherein the step of selecting a product configuration further includes the step of selecting an architecture of at least a component of the product.

10. The product of claim 7, wherein the step of selecting a product configuration further includes the step of selecting a brand identifier of the product.

11. The product of claim 10, wherein the brand identifier comprises a logo.

12. The product of claim 10, wherein the step of selecting a brand identifier further comprises the step of establishing at least one personality characteristic of the product.

13. The product of claim 12, wherein the step of establishing at least one personality characteristic further includes the step of assigning at least one adjective to the personal characteristic.

14. The product of claim 13, wherein the step of correlating the product personality with the visual characteristic further includes the step of correlating the product personality with a perceptual map.

15. The product of claim 1, wherein the step of designing a product based on the correlation further comprises the step of selecting a brand to create a brand identifier.

16. The product of claim 15, wherein the step of selecting a brand to create a brand identifier further includes the step of correlating the brand identifier with a predetermined appearance of at least a component of the product.

17. A method of creating an aesthetically pleasing product, comprising the steps of:
(a) establishing desired brand personalities for a product line;
(b) mapping customer perceptions of the brand personalities;
(c) correlating visual characteristics of the brand personalities to a desired brand;
(d) determining visual characteristics of the desired brand; and
(e) designing a product appearance in response to the visual characteristics of the desired brand.

18. A method of creating brand equity in a product line, comprising the steps of:
(a) assigning desired personality adjectives to a current brand;
(b) associating a plurality of images and a plurality of dominant personality traits to generate an association between the plurality of images with the plurality dominant personality traits;
(c) correlating the association of the images and traits with the adjectives to generate an image adjective profile;
(d) creating a brand visual characteristic by plotting the association on a perceptual map; and
(e) abstracting a design from the plot and the image adjective profile to create a brand visual identifier.

19. A series of appliances, comprising:
a first appliance having an appearance with a visual characteristic correlated to a predetermined product personality; and
a second, different appliance having an appearance with a similar visual characteristic correlated to the product personality.

20. The series of appliances of claim 19, wherein the appliances include at least one of a washer, dryer, refrigerator, freezer, oven, stove, range, counter top appliance, cooktop, grill, hood, dishwasher, and microwave oven.

21. The series of appliances of claim 19, wherein the similar visual characteristic includes at least one of a panel, frame, top, bottom, rollers, stand, contour, dispenser, plating, pan, icon, graphic, color, texture, display, LED display, lever, tray, shelf, bar, lighting, switch, door, handle, knob, button, dial, siding, backing, interior, facade, and shape.

22. The series of appliances of claim 21, wherein the appliances include at least one of a washer, dryer, refrigerator, freezer, oven, stove, range, counter top appliance, cooktop, grill, hood, dishwasher, and microwave oven.
